(19) United States
(12) Patent Application Publication
(10) Pub. No.: US 2005/0254238 A1
(43) Pub. Date: Nov. 17, 2005

(54) Holder for a flashlight

(76) Inventors: David H. Parker, Torrance, CA (US); Kevin Deighton, Long Beach, CA (US)

Correspondence Address: GREENBERG TRAURIG LLP, 2450 COLORADO AVENUE, SUITE 400E, SANTA MONICA, CA, 90404, US

(21) Appl. No.: 10/846,059

(22) Filed: May 14, 2004

(51) Int. Cl. F21V 21/00

(52) U.S. Cl. 362/191; 362/105; 362/396

(57) ABSTRACT

A holder for a flashlight including a single tightening screw for securing flashlights of different widths, between two arms and also for tightening an anchorage associated with the arms with a support. The support is associated with a further securing structure to permit securing the flashlight on a helmet or rim of a helmet or cap. The holder includes flexible arms that are hinged at a position remote from the tightening screw that is adjacent the anchorage.

### RELATED APPLICATION

This application claims priority from U.S. Utility patent application Ser. No. 10/762,954 (to be converted to a provisional application), filed Jan. 21, 2004, the contents of which are hereby incorporated by reference in its entirety.

### BACKGROUND

This disclosure relates to a holder for flashlights on a support. In particular, the disclosure is concerned with holding flashlights on a helmet or cap of a wearer.

Protective helmets are used by laborers in different industries and it is often necessary to supply helmets with a flashlight so that laborers can clearly see objects while performing their work.

Different configurations and structures are known for supporting flashlights on a cap or helmet in that environment. It is particularly difficult when the laborer moves around a lot in different environments. The flashlight needs to be able to effectively point the flashlight at an object. It is also necessary to have the flashlight securely mounted so that the angle cannot inadvertently change. Where a flashlight is relatively heavy, the securing means also needs to provide stability. A minimum number of fixation devices are required for the holder in order to make the holder particularly useful to a wearer. Additionally, the holder needs to be able to accommodate different sized flashlights.

The present disclosure is directed to achieving at least some of these objectives separately and collectively.

### SUMMARY

A holder for a flashlight includes a carrier element, which includes at least two arms. At least one of the arms is relatively flexible so that a space between the arms can vary. This permits for flashlights of different diameters or widths to be accommodated between the arms.

The two arms are hinged at one location, and also respectively have two free ends. Towards the free ends of each arm there is formed an anchorage for a support. The support is for location on a further base, which is usually in the nature of a helmet or cap, or the rim of a helmet or cap. The anchorage and support would ideally be formed to be a universal kind of joint.

Ideally, the anchorage from the end of the arms is a socket and the support is a ball, which rides in the socket. This effectively provides for multi-directional turning of the arms relative to the support. The multi-directional turning can be vertically up and down so that the flashlight can be moved relatively up and down in a vertical sense. The universality of the anchorage and support mechanism is such that the angle can be changed also in a horizontal sense. The combination of vertical and horizontal mobility provides for a multi-directional change of the angle relationship between the arms and the support, such that a broad sweep of angles can be obtained with the structure.

A further aspect of the structure is that between the anchorage and the area for carrying the flashlight, there is provided a tightening element. This is in the form of a threaded shank, which passes from one side of the arm towards the other side of the arm. It engages the other side of the arm in a threaded relationship and a finger turnable head of the threaded shank engages the outside of the arm on the opposite side. Accordingly, as this threaded shank is relatively tightened, it forces the arms relatively together and this permits for securing the flashlight firmly between the arms. At the same time, the single action of the threaded shank operating between the two arms adds to tighten the anchorage support construct.

In yet a further aspect of the disclosure, one of the arms is formed by two separate leg structures and there is a space between these leg structures to form essentially a window type formation. This facilitates the bending abilities of the legs of one of the arms.

The inside of the arms provides space friction engaging elements whereby a flashlight body can engage the elements and thereby slippage is minimized.

In yet a further aspect of the disclosure, the support is secured to a C-clip or member and the C-clip or member on one side includes a threaded bolt and head. Between the leading edge of the bolt and one inside edge of the C, there can be accommodated a cap rim or helmed rim in a secure relationship. The angulation of the C element and the support member is such that the support member is essentially a vertically upstanding element and the C element is angulated relatively downwardly such that an obtuse angle is formed between the upstanding support and the C clip. In this fashion where the rim of the hat is downwardly sloping, the C is anchored securely with the rim with the upstanding support substantially vertical.

In yet a different form of the disclosure the upstanding support is essentially vertically related to a fork-like element, which is similarly vertically directed downwardly. The fork-like element has tine-type configurations. The tine-type configurations are relatively moveable. In different configurations, a helmet or cap can be provided with a slot with one or two steps in the slotted stepped locations in a relatively vertical sense. In this manner, when the tines are directed into the slot for anchorage, a relative degree of lateral movement of the tines in relationship to the longitudinal direction permits a flex such that the tines can be positively accommodated in strategically formed steps or tracks in the support.

The disclosure is further described with reference to the accompanying drawings.

### DRAWINGS

FIG. 1 is a front view of a holder element with a C clamp attached to a rim of a cap or helmet.

FIG. 2 is a perspective view of the carrier element showing the C clamp on the brim and the arms above the C clamp, the arms being for locating the flashlight which is shown diagrammatically extending through the aperture between the arms.

FIG. 3 is a front view showing a different construct of the flashlight holder with a tine-forked member directed for location in a slot in a cap.

FIG. 4 is a perspective view of the configuration of FIG. 3 showing the carrier element with the tined forked element in relationship to the slot into which the forked element would snap for engagement. A flashlight is figuratively shown between the arms.

FIG. 5 is a front view of the embodiment of FIGS. 1 and 2 showing the front of the C type structure and showing the window between two legs of one of the arms.

FIG. 6 is a side view of the embodiment of FIG. 1 showing the C support and the anchor support member interaction. A single threaded shank and head member is located above the anchor support member and below the arms of the cavity in which the flashlight would be supported.

FIG. 7 is a rear view of the configuration of FIGS. 1, 2, 5 and 6.

FIG. 8 is a perspective view of the configuration as shown in FIGS. 1, 2, 5, 6 and 7. The two flexible legs are in the arm, which is engaged with the head of the threadable shank.

FIG. 9 is an alternative to perspective view of the configuration similar to that of FIG. 8. The two flexible legs are in the arm, which is opposite the arm engaged by the head of the threaded shank.

FIG. 10 is a first end view of the configuration illustrated in FIG. 3 showing a forked element with relatively moveable tines and a step for engagement in a slot on a cap rim.

FIG. 11 is a side view showing a holder for a flashlight. A threaded shank passes between two arms and the anchorage support system illustrates as a straight bar for engagement in the slot. The straight bar is a forked element with tines.

FIG. 12 is a front view of the configuration shown in FIG. 10. The tines of the straight bar include reinforced longitudinal elements for facilitating accommodation in a slot in a cap or a helmet. The spaced legs of the one arm are adjacent the side engaged by the head of the threaded shank and in this configuration the window extends through both arms of the holder forming the cavity for the flashlight.

FIG. 13 is a perspective view illustrating an embodiment where the window is formed in one of the arms of the holder for accommodating the flashlight. In this embodiment the window is in the arm, which is adjacent to the head of the threaded shank.

FIG. 14 is an alternative embodiment wherein the window is formed in the arm opposite the arm, which is engaged by the head of the threaded shank.

### DESCRIPTION

An anchorage is provided for engagement with a support. The anchorage and the support are relatively movable such that the arms can adopt different angular positions relative to the support. A tightening element is associated with the anchorage, whereby relative tightening and loosening of the tightening element acts to permit or retard relative movement of the anchorage and the support and also relatively tightens the arms about the flashlight.

Ideally there is only a single tightening element and it acts to provide the tightening of the arms about the flashlight and the tightening of the anchorage and the support. The tightening element is a threaded shank that passes through a threaded bore in an extension of one of the arms. The bore is located between a main length of the arms and the anchorage location. The leading end of the threaded shank engages the other arm at a location between the other arms. A head for the shank is, operable under finger motion to effect screwing and unscrewing of the shank relative to the two arms.

The shank threadingly engages only the arm that is remote from the arm adjacent the head and turning of the shank causes the remote arm to move closer or further to the arm adjacent the head, the arm adjacent the head and the head being in abutting relationship.

The anchorage and support are a ball and socket, and the socket is formed at leading ends of the arms, and the ball being formed on a protrusion from a securing member of the support.

The securing member includes an element remote from the ball being for engagement with a helmet and being selectively a clamp for engagement on a rim of a cap or a bar for snapped relationship in a slot on the cap. The securing member with a clamp is for location on a cap rim and includes a relatively flat element or plate for parallel engagement with the cap rim. The securing member extends at a non-right angular relationship relative to the cap rim such that in use this support is relatively vertically disposed and the element or plate for the cap rim is downwardly angled relative to a horizontal disposition.

The securing member for the cap rim includes a C-shaped member and wherein the edge of the cap rim is located within the C shaped member and an arm of the C below the cap includes a threaded member for engagement underneath the cap rim in a tightening or loosening relationship.

The bar is an elongated straight bar, and there are forked limbs which are relatively flexible. The limbs are for extension into a slot provided in the rim of the cap or adjacent to the side of the cap substantially abutting the rim. The slot includes at least one engagement structure for mating engagement with a leg of the forked structure.

At least one of the arms includes two spaced members, the spaced members being relatively resilient and wherein between the spaced members there is a window formation.

The two arms are hingedly connected at the end remote from the anchorage such that with the threaded tightening element removed from its engagement between the two arms, the arms can be opened about the hinge.

There is a friction element in space between the arms, the friction element being for facilitating the anchorage of the flashlight.

A holder 100 for a flashlight includes two spaced arms 20 and 22. The arms are hingedly connected through a hinge 24 at one end so that the arms can open and close as indicated by arrow 26. The hinge is formed through a pin 28 which passes through to bores 30 and 32 which mate in a piano hinge type formation so that the pin 28 can extend through those two bores.

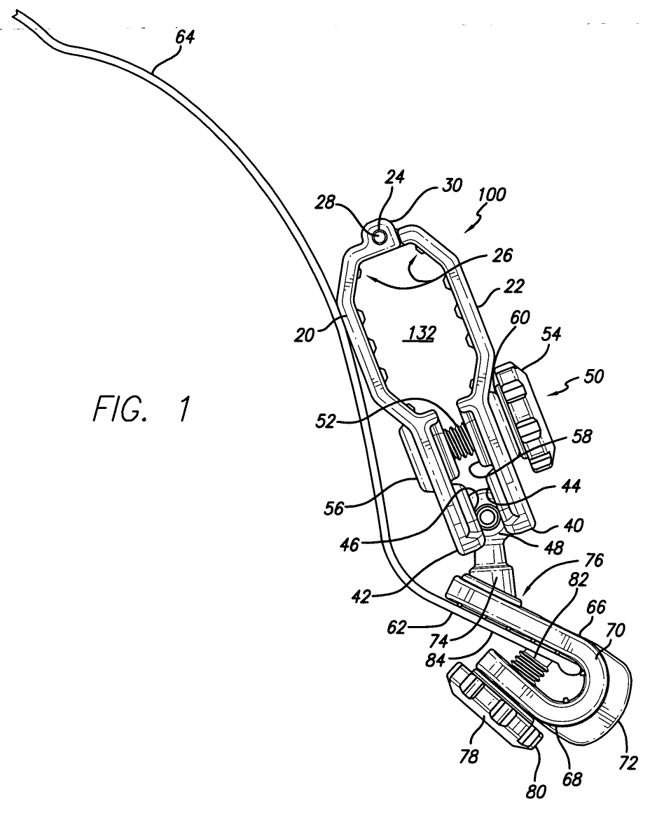

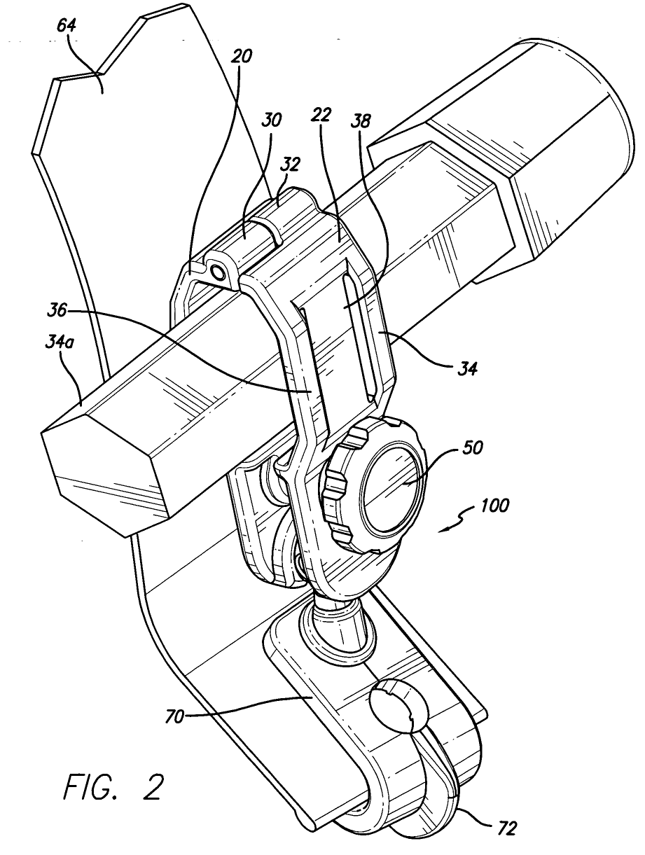

Between the two arms 20 and 22 there is formed a cavity 132 for accommodating a flashlight 34a. The flashlight is accommodated so that its diameter, circumference and/or width can be securely located in the cavity 132. The arm 22 of the configuration in FIG. 1 includes two legs, 34 and 36 which are spaced apart so that a window formation 38 is formed between the legs 34 and 36. The opposite arm 20 does not have the legs 34 and 36 but is a relatively solid configuration.

The arms 22 and 20 have two free ends 40 and 42, respectively. Formed towards the free ends 40 and 42, respectively, are half sockets 44 and 46. The half sockets accommodate a ball 48 so that the two half sockets 44 and 46 and ball 48 forms a universal type joint or anchorage for the holder and the two arms 20 and 22. Between the cavity 132 and the half socket portions 44 and 46 there is a length of the respective arms 20 and 22, which accommodates a tightening member 50.

The tightening member includes a threaded shank 52 and a finger operable head on a nut 54. The leading end of the threaded shank 52 engages mating threads 56 in the extension of arm 20 between the areas formed by the cavity and the area formed by the half socket. In the mating arm 22, the threaded member 52 passes through a bore 58 and the threaded head 54 engages the outside surface 60 of the arm 22.

The configuration is such that the tightening of the head 54 causes the tightening member 50 to engage the surface 60 of arm 22. This causes the relative tightening of the arms 20 and 22 or drawing together of those arms. This tightening has two effects. One effect is to relatively tighten or close the cavity 132 about a flashlight 34a which would be located in the cavity. At the same time the two half sockets 44 and 46 are drawn tighter to the ball 48, and this adds to tighten the engagement of the anchorage on the support.

The structure for securing the holder to the brim 62 of a cap 64 includes a C type anchorage 66 with two arms 68 and 70 and a U shaped connector portion 72. The arm 70 is designed to be angled relatively downwardly and the pedestal 74 is designed to be relatively upwardly and vertically directed. As such, therefore, there is a relatively obtuse angle 76 formed between the arm 70 and the upright pedestal 74.

The arm 60 includes an aperture which is threaded and is for engaging a nut structure 78 with the head 80 on the remote side of the C and the leading end 82 for engagement on the inside surface 84 of the brim 62. Tightening and loosening of the nut 82 effects securing of the C type support on the brim 62 of the helmet or cap 64.

By having the single nut configuration 50 between the anchorage support structure 40, 42 and 44 and the cavity 132 there is achieved a situation that solely a single tightening configuration is used to do both the function of tightening the flashlight 34 in the cavity 132 and tightening the anchorage and support of the configuration. The relative flexibility of at least one of the arms 20 and 22 permits for the arms of the holder to flex and permit for snug accommodation of a flashlight body in the cavity 132.

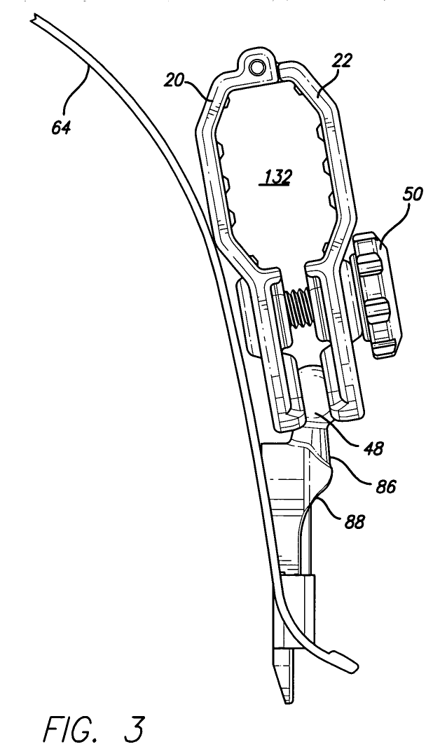

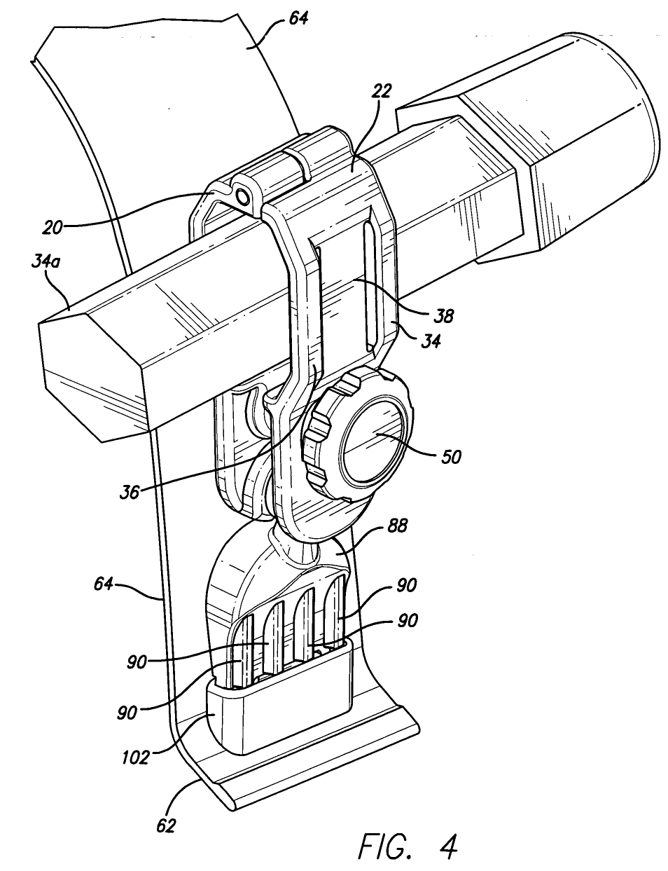

In the configuration of the holder illustrated in FIG. 3 the configuration of the cavity tightening means and ball and socket is similar. The support structure for location with a hat or cap 64, however, is different. Depending from the ball 48 there is a pedestal 86, which engages a forklike structure 88.

The structure is in the sense of a straight bar with four reinforced tine-like elements 90 which are spaced apart. The four tine-like elements end in two extending peripheral tines 92 in a central tongue-like element 94. One side of the tongue-like element 94 includes a step 96 and the other side 98 is relatively flush. The tine-like elements 90 are on the opposite side of the step 96.

The configuration is formed so that the fork like element or plate 88 is accommodated in a slot 102, which is formed at the interface of the brim 62 and the head covering portion of the cap 64. The slot 102 can have one or two mating configurations so that the tines 92 and 94 can easily be accommodated through the aperture formed in the slot 102. Moving the tine 94 forwardly or backwardly as indicated by arrow 114 can cause the arm 88 to be released and/or securely located in the slot 102 as may be necessary.

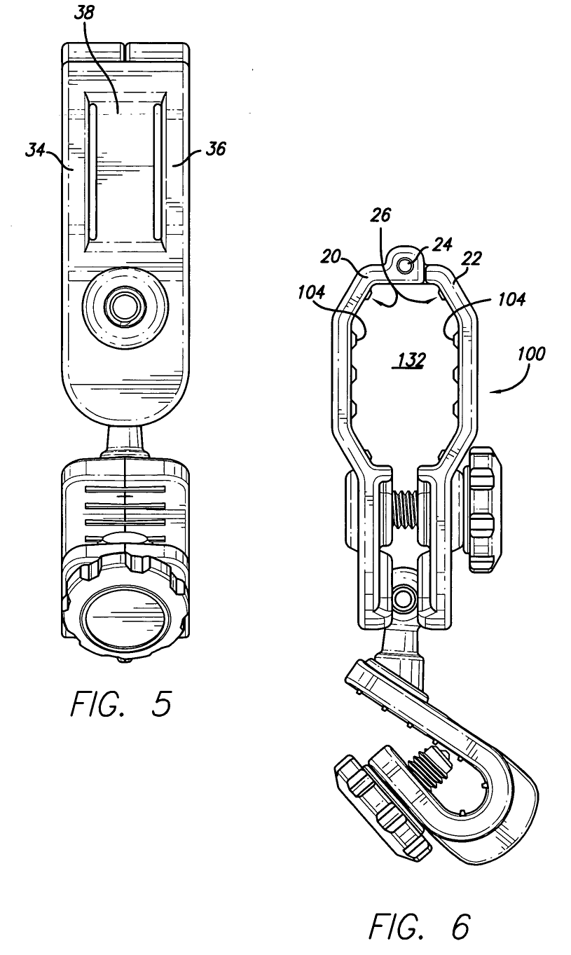

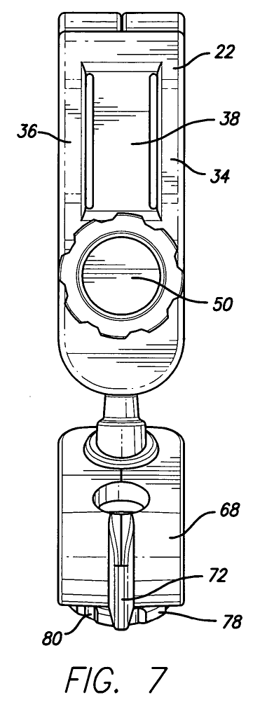

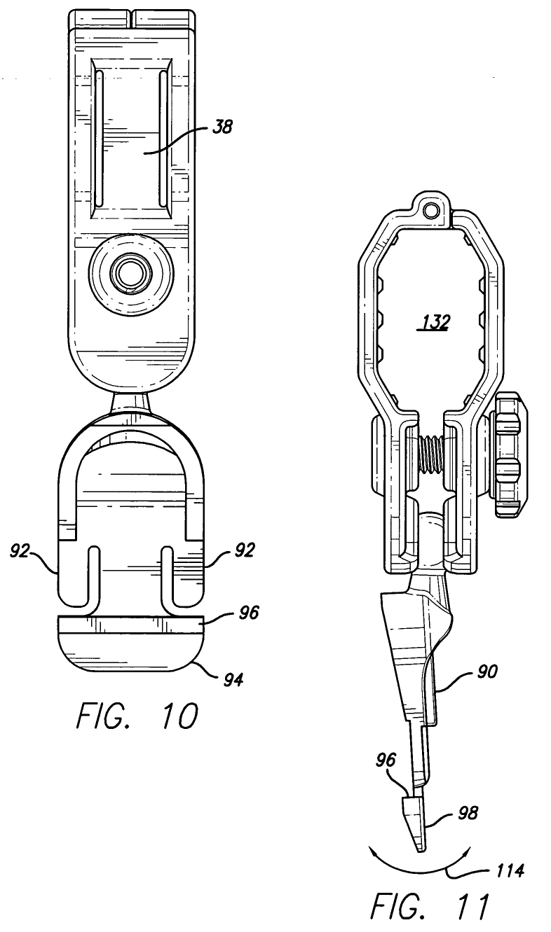

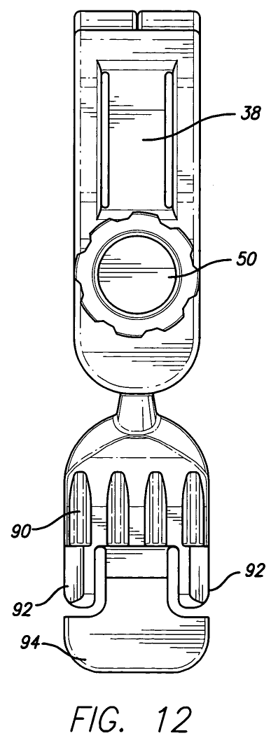

Many other forms of the invention exist each different from the other in matters of detail only. As illustrated in FIG. 5, the window 38 extends through both of the arms 20 and 22 between the legs 34 and 36. This is a similar construct in FIGS. 7, 10. and 12.

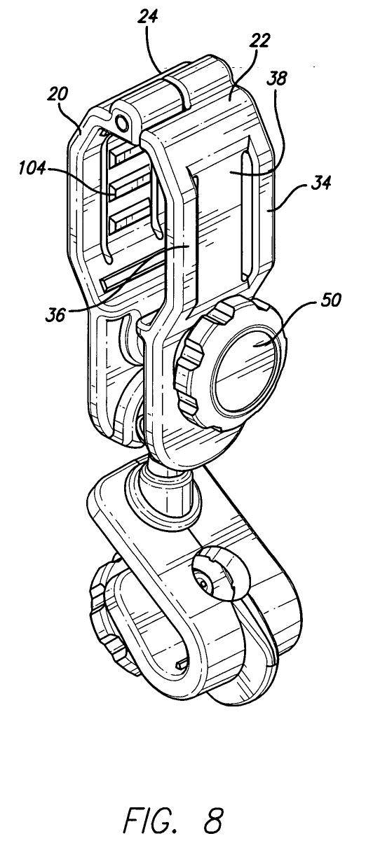

In the configuration shown in FIG. 8 the window 38 is formed between the arms 34 and 36 on that arm which is adjacent to the nut 50. The opposite arm is relatively solid. There are friction-engaging members 104 in that opposite arm where a window would otherwise be located. These friction engaging members 104 can also be located in different other spaces of the cavity on the inside of either one of the arms 20 or 22 as may be desired.

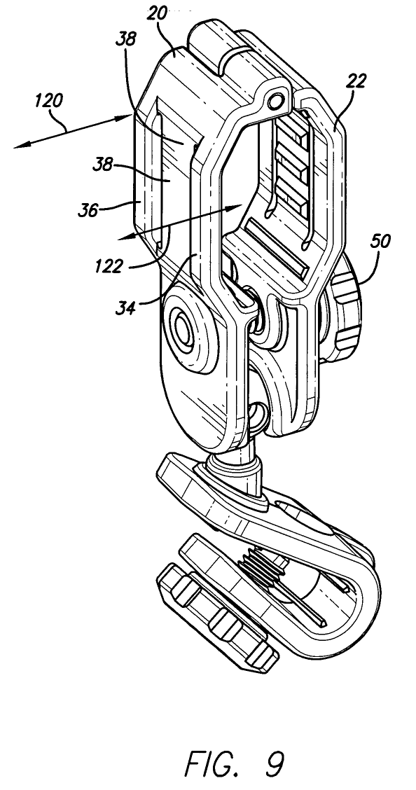

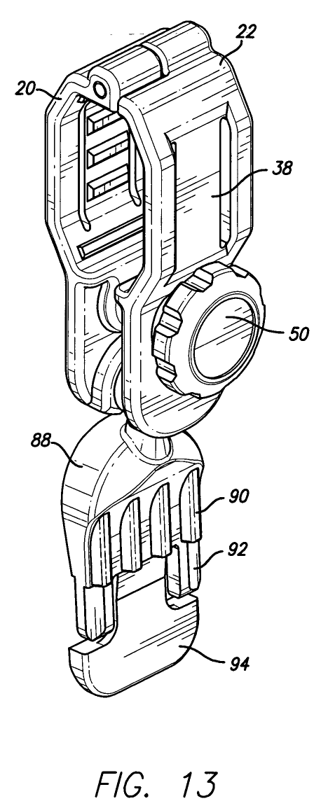

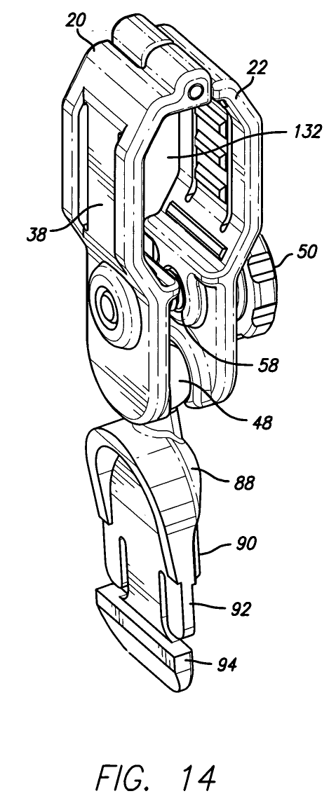

In the configuration of FIG. 9 the window 38 is formed in the arms, which is opposite to the arm which engages the nut 50 of the anchorage means. Similar different configurations are shown in FIGS. 13 and 14.

As shown in FIG. 9 for example, the arrows 120 and 122 exhibit the flex of the legs 34 and 36 of the arm 20. Similar legs and flex can be part of arm 22 in this or other embodiments.

Many other forms of the invention exist each differing from the other in matters of detail only. For instance, instead of one arm having the 2 flexible legs, both arms can have this. Different formats of frictional devices can be supplied to the space. The carrier for accommodating a flashlight can be a single arm for embracing a flashlight body, the arm being relatively flexible to thereby accommodate different width flashlights. In yet other forms there can be more than one tightening member for the arm and the support/anchorage mechanism. Different formats of support/anchorage mechanism are possible.

The invention is to be determined solely by the following claims.

1. A flashlight holder comprising:
a carrier for accommodating a flashlight, the carrier including at least one arm for extending along one side of the flashlight, at least another arm for extending along another side of the flashlight, the two arms being connected together towards one end, and a tightening element is connected towards an opposite end, and there being a space between the arms, the space being of variable size to thereby accommodate different width flashlights;
an anchorage for engagement with a support, the anchorage and the support being relatively movable such that the arms can adopt different angular positions relative to the support;
the tightening element being associated with the anchorage, whereby relative tightening and loosening of the tightening element acts to permit or retard relative movement of the anchorage and the support and also relatively tightens the arms about the flashlight.

2. A holder as claimed in claim 1 wherein only a single tightening element acts to provide the tightening of the arms about the flashlight and the tightening of the anchorage and the support.

3. A holder as claimed in claim 1 wherein the tightening element includes a threaded shank which passes through a threaded bore in an extension of one of the arms, and the bore being located between a main length of the arms and the anchorage location and wherein the leading end of the threaded shank engages the other arm at a location between the other arm and the anchorage and including a head for the shank, the head being operable under finger motion to effect screwing and unscrewing of the shank relative to the two arms.

4. A holder as claimed in claim 3 wherein the shank threadingly engages only the arm that is remote from the arm adjacent the head and wherein turning of the shank causes the remote arm to move closer or further to the arm adjacent the head, the arm adjacent the head and the head being in abutting relationship.

5. A holder as claimed in claim 4 wherein the anchorage and support are a ball and socket, the socket being formed towards the leading ends of the arms, and the ball being formed on a protrusion from a securing member of the support.

6. A holder as claimed in claim 5 wherein the securing member includes an element remote from the ball being for engagement with a helmet and being selectively a clamp for engagement on a rim of a cap or a bar for snapped relationship in a slot on the cap.

7. A holder as claimed in claim 6 wherein the securing member with a clamp for location on a cap rim includes a relatively flat element or plate for parallel engagement with the cap rim and the securing member extends at a non-right angular relationship relative to the cap rim such that in use this support is relatively vertically disposed and the element or plate for the cap rim is downwardly angled relative to a horizontal disposition.

8. A holder as claimed in claim 7 wherein the securing member for the cap rim includes a C-shaped member and wherein the edge of the cap rim is located within the C shaped member and an arm of the C below the cap includes a threaded member for engagement underneath the cap rim in a tightening or loosening relationship.

9. A holder as claimed in claim 5 wherein the bar is an elongated straight bar, the straight bar having forked limbs which are relatively flexible, the limbs being for extension into a slot provided in the rim of the cap or adjacent to the side of the cap substantially abutting the rim and wherein the slot includes at least one engagement structure for mating engagement with a leg of the forked structure.

10. A holder as claimed in claim 1 wherein at least one of the arms includes two spaced members, the spaced members being relatively resilient and wherein between the spaced members there is a window formation.

11. A holder as claimed in claim 1 wherein the two arms are hingedly connected at the end remote from the anchorage such that with the threaded tightening element removed from its engagement between the two arms, the arms can be opened about the hinge.

12. A flashlight holder comprising:
a carrier for accommodating a flashlight, the carrier including an arm for extending along one side of the flashlight, an arm for extending along another side of the flashlight, the two arms being connected together, preferably in a hinged relationship at one end, and a tightening element being screw connected at an opposite end, at least one of the arms being relatively flexible to thereby accommodate different width flashlights, at least one of the arms being relatively flexible, and selectively including two spaced resilient members;
an anchorage for engagement with a support, the anchorage and the support being relatively movable such that the arms can adopt different angular positions relative to the support; and
the tightening element being associated with the anchorage, whereby relative tightening and loosening of the tightening element acts to permit or retard relative movement of the anchorage and the support and also relatively tightens the arms about the flashlight.

13. A holder as claimed in claim 12 wherein only a single tightening element acts to provide the tightening of the arms about the flashlight and the tightening of the anchorage and the support.

14. A holder as claimed in claim 13 wherein the tightening element engages only the arm that is remote from the arm adjacent the head and wherein the tightening causes the remote arm to move closer or further to the arm adjacent the head, the arm adjacent the head and the head being in abutting relationship.

15. A holder as claimed in claim 14 wherein the anchorage and support are a ball and socket, the socket being formed at leading ends of the arms, and the ball being formed on a protrusion from a securing member of the support.

16. A holder as claimed in claim 15 wherein the securing member includes an element remote from the ball being for engagement with a helmet and being selectively a clamp for engagement on a rim of a cap or a bar for snapped relationship in a slot on the cap.

17. A holder as claimed in claim 16 wherein the securing member with a clamp for location on a cap rim includes a relatively flat element or plate for parallel engagement with the cap rim and the securing member extends at a non-right angular relationship relative to the cap rim such that in use this support is relatively vertically disposed and the element or plate for the cap rim is downwardly angled relative to a horizontal disposition.

18. A flashlight holder comprising:
a carrier for accommodating a flashlight, the carrier including an arm for extending along one side of the flashlight, an arm for extending along another side of the flashlight, the two arms being connected together, preferably in a hinged relationship at one end, and a tightening element being screw connected at an opposite end, at least one of the arms being relatively flexible to thereby accommodate different width flashlights, at least one of the arms being relatively flexible, and selectively including two spaced resilient members;
an anchorage for engagement with a support, the anchorage and the support being relatively movable such that the arms can adopt different angular positions relative to the support;
the tightening element being associated with the anchorage, whereby relative tightening and loosening of the tightening element acts to permit or retard relative movement of the anchorage and the support and also relatively tightens the arms about the flashlight; and
the two arms being hingedly connected at the end remote from the anchorage such that with the tightening element removed from its engagement between the two arms, the arms can be opened about the hinge.

19. A holder as claimed in claim 1 including a friction element in space between the arms, the friction element being for facilitating the anchorage of the flashlight.

20. A holder as claimed in claim 12 including a friction element in space between the arms, the friction element being for facilitating the anchorage of the flashlight.

21. A flashlight holder comprising:
a carrier for accommodating a flashlight, the carrier including an arm for embracing a flashlight body, and a tightening element for tightening the arm about the flashlight body, the arm being relatively flexible to thereby accommodate different width flashlights;
an anchorage for engagement with a support, the anchorage and the support being relatively movable such that the arm can adopt different angular positions relative to the support; and
the tightening element being associated with the anchorage, whereby relative tightening and loosening of the tightening element acts to permit or retard relative movement of the anchorage and the support and also relatively tightens the arm about the flashlight.

22. A holder as claimed in claim 21 wherein only a single tightening element acts to provide the tightening of the arm about the flashlight and the-tightening of the anchorage and the support.
